(19) United States
(12) Patent Application Publication
(10) Pub. No.: US 2014/0207530 A1
(43) Pub. Date: Jul. 24, 2014

(54) FAIRLY CALIBRATED DISTRIBUTION MATRIX MODELING

(71) Applicants: Scott Alan Seese, Saratoga, CA (US); Sezhiyan Balasubramaniam, Fremont, CA (US); Venkatachalam Rangasamy, San Jose, CA (US); Aparna Lingam, Santa Clara, CA (US); Kanagaraj Dhandapani, San Jose, CA (US)

(72) Inventors: Scott Alan Seese, Saratoga, CA (US); Sezhiyan Balasubramaniam, Fremont, CA (US); Venkatachalam Rangasamy, San Jose, CA (US); Aparna Lingam, Santa Clara, CA (US); Kanagaraj Dhandapani, San Jose, CA (US)

(73) Assignee: EBAY INC., SAN JOSE, CA (US)

(21) Appl. No.: 14/160,354

(22) Filed: Jan. 21, 2014

Related U.S. Application Data
(60) Provisional application No. 61/754,736, filed on Jan. 21, 2013.

(51) Int. Cl. G06Q 10/06

(52) U.S. Cl. CPC G06Q 10/0639
USPC 705/7.38

(57) ABSTRACT

The present disclosure provides for evaluating and managing multi-dimensional performance data of individual entities and their group as a whole by producing unbiased bell curved distributions according to organizational, product, manufacturing, or other goals and/or guidelines. An exemplary two dimensional performance management model may display a grid with potential along a first axis and performance along a second axis. Individual entities are placed into boxes defined by an evaluation metric grid matrix. Unbiased and evenly distributed performance rankings are produced with automated bell curve distribution simulation from the matrix data. A user may view the bell curve distributions as a holistic result or according to one or more independently calculated factors or criteria(s). The bell curve distribution simulation method will alert the manager if the operational and strategic guide lines of the organization are not followed.

### CLAIM OF PRIORITY

This application claims the benefit of priority to U.S. Provisional Patent Application Ser. No. 61/754,736, filed on Jan. 21, 2013, which is incorporated by reference herein in its entirety.

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright eBay, Inc. 2013, All Rights Reserved.

### BACKGROUND

1. Field

The present invention relates generally to calibrating data, and more specifically to calibrating data to produce evenly distributed unbiased performance rankings.

2. Background

Managing the ever increasing amount of data related to the comparative performance of a group of entities such as stocks, athletes, chemical compounds, pharmaceutical candidates or corporate employees becomes exponentially complicated when the performance criteria is multi-dimensional. For example, a two dimensional performance analysis methodology can be based on a combination of actual goal completion or past performance record as well as future potential of individual entities, or a group as a whole. While, for purposes of simplicity of explanation, the evaluation and management methodologies are shown and described here as a two dimensional analysis of employee performance, it is to be understood and appreciated that the methodologies are not limited to employee entities or two dimensions. Nor are these methodologies limited by the order of acts, as some acts may, in accordance with one or more embodiments, occur in different orders and/or concurrently with other acts from those shown and described herein. For example, those skilled in the art will understand and appreciate that a methodology could alternatively be applied to any entities having varying types and numbers of evaluation criteria. Moreover, not all illustrated acts may be required to implement a methodology in accordance with one or more embodiments.

For example, in a corporate environment, employees are the most valuable asset of an organization. Motivating and attracting employees often requires that the company invest resources to develop the employees. Many companies hold employee performance review meetings at least once a year to evaluate employee potential and performance. Companies typically set organizational guide lines, which drive the employee review and evaluation process. Organizational goals may determine which, and how many, employees are assessed as having a high potential value to the company. In this embodiment, the presently disclosed Fairly Calibrated Distribution Matrix Model is the most advantageous method for ensuring that the operational and strategic goals of an organization related to talent performance management are fairly and accurately met.

Traditional methods for performing employee reviews are time consuming and lead to costly errors and/or unfairness because multi-dimensional information is not readily available, or the information is not presented to the reviewer in a proper multidimensional context. The enormous amount of information relevant to performing employee evaluations in substantial organizations is rarely flat, or one dimensional and often leads to less-than-optimum decisions that do not result in fairly distributed compensation or selecting the best employees for future organization development.

There is therefore a need in the art for accurately calibrating multi-dimensional performance data to produce evenly distributed and unbiased performance rankings.

### BRIEF DESCRIPTION OF THE DRAWINGS

Some embodiments are illustrated by way of example and not limitation in the figures of the accompanying drawings.

FIG. 1 is a network diagram illustrating a network environment suitable for Fairly Calibrated Distribution Matrix Modeling, according to some example embodiments;

FIG. 2 is a high level block diagram illustrating components for Fairly Calibrated Distribution Matrix Modeling, according to some example embodiments;

FIG. 3 Shows a block diagram of a high level overview flow chart of Fairly Calibrated Distribution Matrix Modeling, according to some example embodiments;

FIG. 4 is a high level overview functional diagram illustrating operations of Fairly Calibrated Distribution Matrix Modeling, according to some example embodiments;

FIG. 5 is a high level overview functional diagram of an automated bell curve distribution simulation module for Fairly Calibrated Distribution Matrix Modeling, according to some example embodiments;

FIG. 6 shows an overview block diagram of an automated bell curve distribution simulation module for Fairly Calibrated Distribution Matrix Modeling, according to some example embodiments;

FIGS. 7-10 illustrate user interfaces for Fairly Calibrated Distribution Matrix Modeling showing automated bell distribution simulation system module output, according to some example embodiments; and

FIG. 11 is a block diagram illustrating components of a machine, according to some example embodiments, able to read instructions from a machine-readable medium and perform any one or more of the methodologies for Fairly Calibrated Distribution Matrix Modeling discussed herein.

### DETAILED DESCRIPTION

The word “exemplary” is used herein to mean “serving as an example, instance, or illustration.” Any embodiment described herein as “exemplary” is not necessarily to be construed as preferred or advantageous over other embodiments.

Example methods and systems are directed to facilitating Fairly Calibrated Distribution Matrix Modeling. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

The present disclosure provides for evaluating and managing multi-dimensional performance data of individual entities and their group as a whole by producing unbiased bell curved distributions according to organizational, product, manufacturing, or other goals and/or guidelines. An exemplary two dimensional performance management model may display a grid with potential along a first axis and performance along a second axis. A user then places each individual entity into one of the boxes defined by a Fairly Calibrated Distribution Matrix Model. In one exemplary embodiment, a 24 box performance versus potential grid models a group of fairly distributed employee rankings and automated bell curve distribution simulations are produced. An employee may be tentatively moved from one box to another box within the grid until a user saves the current grid placements. The number of employees permitted in a given grid box may depend on the operational and strategic goals of the employer's organization. The user, or personnel manager in this embodiment, may review, analyze and manage human resource performance within the organization for the current grid placements based on employee performance and potential metrics specified by the employment organization. Bell curve distribution simulations are produced for current grid placements in table, chart, and graph formats. The user may view the bell curve distributions as a holistic result or according to one or more independently calculated factors or criteria(s). The bell curve distribution simulation method will alert the manager if the operational and strategic guide lines of the organization are not followed during employee's performance evaluation based on the employee's placements in the 24 box grid. For example, separate performance curves may be calculated for individual, as well as a combination of, pay grades, race, or gender.

One skilled in the art would realize that while for purposes of simplicity of explanation, the Fairly Calibrated Distribution Matrix Modeling methodologies are shown and described here as a two dimensional analysis of employee performance, it is to be understood and appreciated that the methodologies are not limited to employee entities or two dimensions. The Fairly Calibrated Distribution Matrix Modeling methodologies are readily applicable to any entity type, grid size or matrix dimensions where traditional flat, one dimensional evaluations do not allow for multiple evaluation factors or produce even distributions for more than one evaluation factor or criteria. For example, stocks, athletes, chemical compounds, pharmaceutical candidates, livestock, and manufactured devices among other entities may benefit from multi-dimensional performance analysis and unbiased ranking. Fairly calibrated distribution matrix models may provide mechanisms for avoiding the purchase of underperforming stocks or merchandise, unfair employment practices, and the like. Accordingly, the models may be analyzed to determine a fair distribution of pay raises and promotions or any other analytical comparisons involving multiple or subjective criteria factors.

Example methods and systems to fairly calibrate and manage performance data are described. In the following description, for purposes of explanation, numerous specific details are set forth in order to provide a thorough understanding of example embodiments. It will be evident, however, to one skilled in the art that the present invention may be practiced without these specific details.

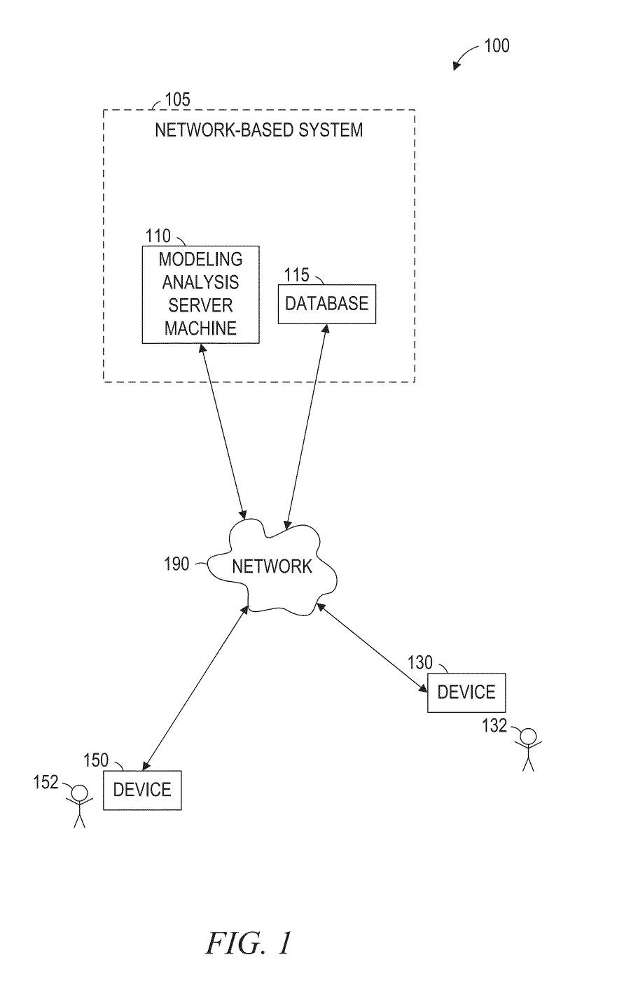

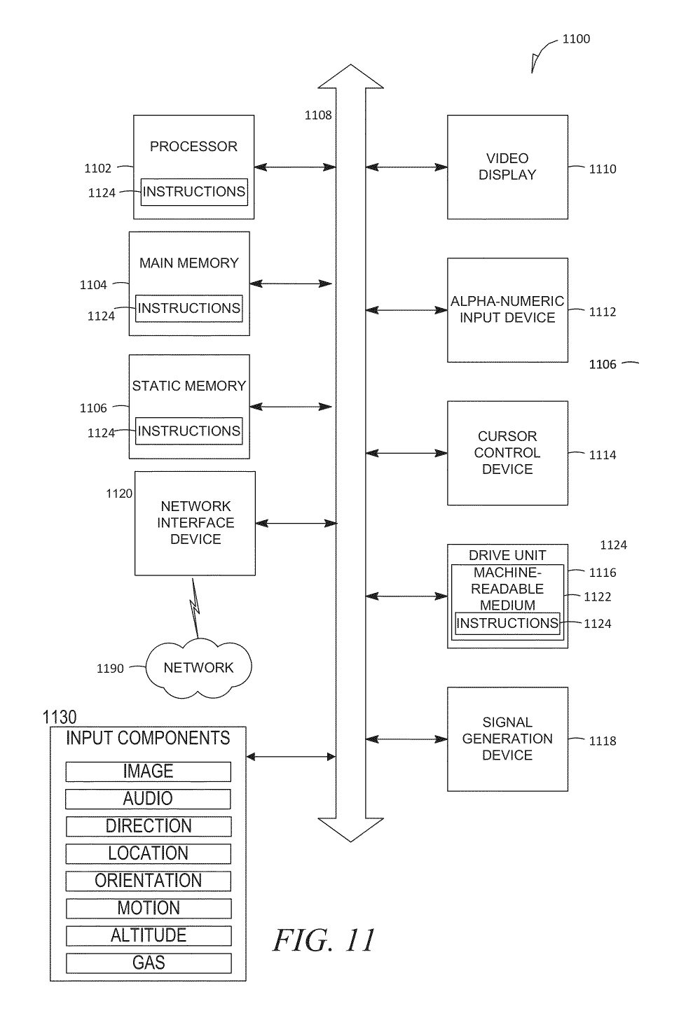

FIG. 1 is a network diagram illustrating a network environment 100 suitable for Fairly Calibrated Distribution Matrix Modeling, according to some example embodiments. The network environment 100 includes a network based system 105 having a Modeling Server Analysis Machine 110, a database 115, having devices 130 and 150, all communicatively coupled to each other via a network 190. In some example embodiments, users 132 and 152 are connected by the network 190 to the Modeling Server Analysis Machine 110 and the devices 130 and 150, while other devices are connected to the Modeling Server Analysis Machine 110 by a separate network. The Modeling Server Analysis Machine 110, data base 115 and the devices 130 and, 150 may each be implemented in a computer system, in whole or in part, as described below with respect to FIG. 11.

Also shown in FIG. 1 are users 132 and 152. One or both of the users 132 and 152 may be a human user (e.g., a human being), a machine user (e.g., a computer configured by a software program to interact with the device 130), or any suitable combination thereof (e.g., a human assisted by a machine or a machine supervised by a human). The user 132 is not part of the network environment 100, but is associated with the device 130 and may be a user of the device 130. For example, the device 130 may be a desktop computer, a vehicle computer, a tablet computer, a navigational device, a portable media device, or a smart phone belonging to the user 132. Likewise, the user 152 is not part of the network environment 100, but is associated with the device 150. As an example, the device 150 may be a desktop computer, a vehicle computer, a tablet computer, a navigational device, a portable media device, or a smart phone belonging to the user 152.

Any of the machines, databases, or devices shown in FIG. 1 may be implemented in a general-purpose computer modified (e.g., configured or programmed) by software to be a special-purpose computer to perform one or more of the functions described herein for that machine, database, or device. For example, a computer system able to implement any one or more of the methodologies described herein is discussed below with respect to FIG. 11. As used herein, a “database” is a data storage resource and may store data structured as a text file, a table, a spreadsheet, a relational database (e.g., an object-relational database), a triple store, a hierarchical data store, or any suitable combination thereof. Moreover, any two or more of the machines, databases, or devices illustrated in FIG. 1 may be combined into a single machine, and the functions described herein for any single machine, database, or device may be subdivided among multiple machines, databases, or devices.

The network 190 may be any network that enables communication between or among machines, databases, and devices (e.g., the Modeling Modeling ServerAnalysis Machine 110 and the device 130). Accordingly, the network 190 may be a wired network, a wireless network (e.g., a mobile or cellular network), or any suitable combination thereof. The network 190 may include one or more portions that constitute a private network, a public network (e.g., the Internet), or any suitable combination thereof. Accordingly, the network 190 may include one or more portions that incorporate a local area network (LAN), a wide area network (WAN), the Internet, a mobile telephone network (e.g., a cellular network), a wired telephone network (e.g., a plain old telephone system (POTS) network), a wireless data network (e.g., WiFi network or WiMax network), or any suitable combination thereof. Any one or more portions of the network 190 may communicate information via a transmission medium. As used herein, “transmission medium” refers to any intangible medium that is capable of storing, encoding, or carrying instructions for execution by a machine, and includes digital or analog communication signals or other intangible media to facilitate communication of such software.

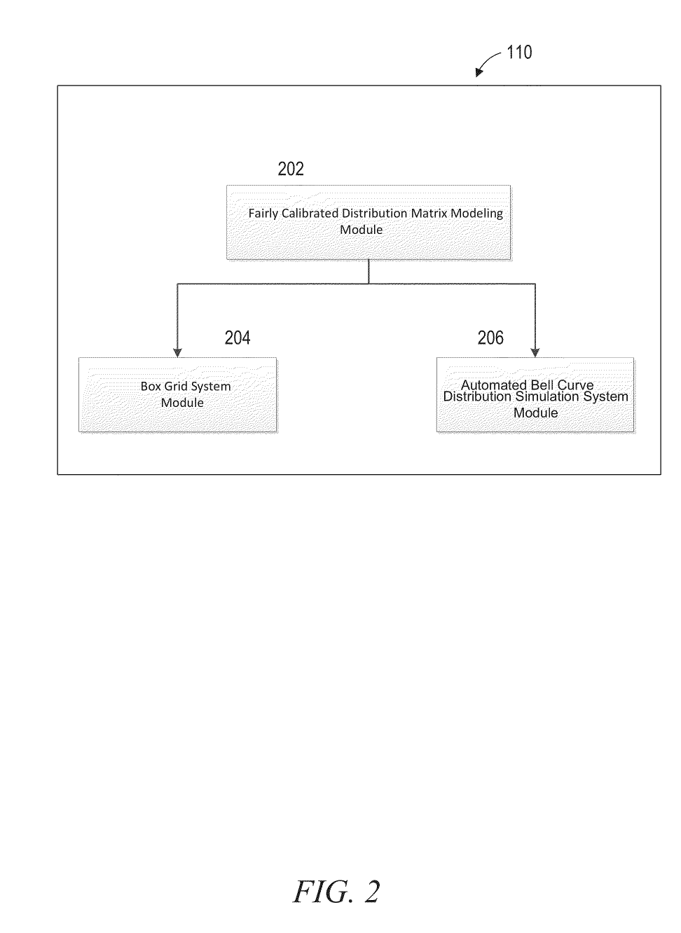

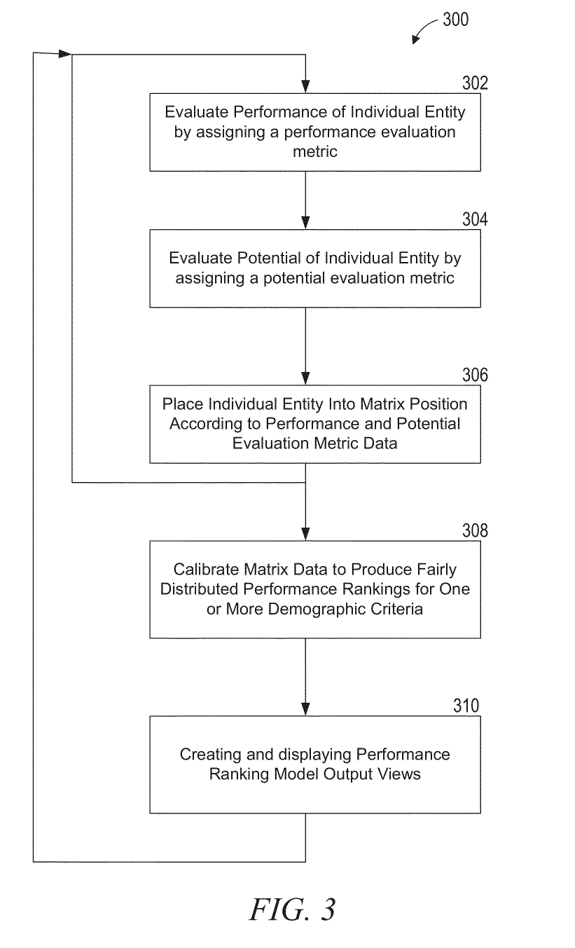

FIG. 2 is a high level block diagram illustrating component modules of the Modeling Analysis Server Machine 110 for Fairly Calibrated Distribution Matrix Modeling, according to some example embodiments. The Modeling Analysis Server Machine 110 may be configured as a cloud-based server machine (e.g., providing a cloud-based service analyzing stream selection commands sent by the user 132, via the portable or fixed device 130). The Modeling Analysis Server Machine 110 is shown as including a Fairly Calibrated Distribution Matrix Modeling Module 202, a Box Grid System Module 204, and an Automated Bell Curve Distribution Simulation module 206, all configured to communicate with each other (e.g., via a bus, shared memory, or a switch). Any one or more of the modules described herein may be implemented using hardware (e.g., a processor of a machine) or a combination of hardware and software. For example, any module described herein may configure a processor to perform the operations described herein for that module. Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices. Further details of the Modeling Analysis Server Machine 110 modules are described below with respect to FIG. 3-13.

FIG. 3 is a flowchart illustrating operations of the Modeling Analysis Server Machine 110 and/or portable or fixed device 130 in performing a method 300 of Fairly Calibrated Distribution Matrix Modeling by user 132, according to some example embodiments. Operations in the method 300 may be performed by the Modeling Analysis Server Machine 110 and/or portable or fixed device 130 using modules described above with respect to FIG. 1-2. As shown in FIG. 3, the method 300 includes operations 302, 304, 306, 308 and 310.

In operation 302, the Fairly Calibrated Distribution Matrix Modeling Module 202 accepts a performance evaluation metric, or value, from the user 132 at the portable or fixed device 130. The performance evaluation metric is assigned to an individual entity specified by the user 132. In the employee ranking embodiment, a personnel manager may assign a performance evaluation metric of Does Not Meet, Meets Some, Meets, Exceeds Some, Exceeds Most or Unassigned to the individual employee. The personnel manager may select a performance evaluation metric based on the completed number or percentage of goals and/or conditions defined for the employee by the manger during the review period. Control flow proceeds to operation 304.

In operation 304, the Fairly Calibrated Distribution Matrix Modeling Module 202 accepts a potential evaluation metric, or value, from the user 132 at the portable or fixed device 130. The potential evaluation metric is assigned to an individual entity specified by the user 132. In the exemplary employee ranking embodiment, a personnel manager may assign a potential evaluation metric of Low, Medium, High or Unassigned to the individual employee. The personnel manager may select a potential evaluation metric based on predefined and/or subjective criteria. Potential evaluation criteria and metric assignments may be reviewed and approved by some or all of the mangers within a holistic group, such as a department or team, for fairness before assignment. Each unique combination of performance evaluation and potential evaluation corresponds to well-defined placement levels to which employees would be tagged. In the employee ranking embodiment, the employee may be tagged with a talent level, effort level and so on. Control flow proceeds to operation 306.

In operation 306, the Box Grid System module 204 places the individual entity in an N×N box grid, where N is an integer, according to its tagged placement level. In the exemplary employee ranking embodiment, the employee may be placed in a 24 box grid system where an X axis of a 2 dimensional graph represents the human resource metrics of performance and a Y axis of the 2 dimensional graph represents the human resource of potential. This Box Grid System module 204 provides a user 132 with the functionality to move the individual employee from one box to another box, where the movement is tentative until saved. Here, the two axis of the graph represent the human resource metrics of potential and performance. One axis of the graph represents the performance and other axis represents the potential. This module provides the functionality to move the employee from one box to another box and the movement is tentative until users click the save button. The Box Grid System module provides an advantageous evolution of traditional one dimensional talent management systems. Operations 302 through 306 are repeated until all of the entities in the group to be evaluated are tagged and placed in a box grid. When the grid is fully populated, control proceeds to operation 308.

In operation 308, the Automated Bell Curve Distribution Simulation System module 206 calibrates the evaluation data contained in the box grid to produce fairly and evenly distributed performance rankings for one, or a combination of, evaluation criteria as well as the group of entities as a whole. Control flow proceeds to operation 310.

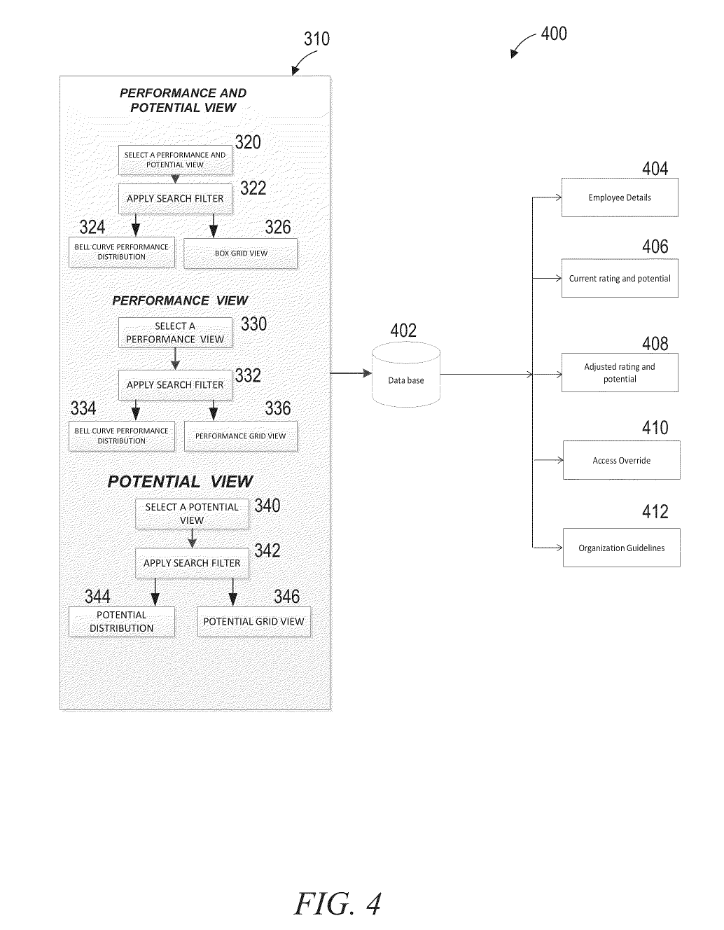

In operation 310, the Fairly Calibrated Distribution Matrix Modeling Module 202 creates and outputs one dimensional table and spreadsheet (i.e. flat) representations, and two dimensional graphical representations, of the current fairly and evenly distributed ranking simulations for the saved entity assignments selected by the user 132. The user 132 may view the rankings in the selected output format to determine that the organizational, product, manufacturing, or other goals and/or guidelines have been met by the current distribution. If the user is not satisfied, Steps 302-306 may be repeated as necessary to achieve the goals and guidelines. The operations for performing method 300 of Fairly Calibrated Distribution Matrix Modeling for the employee ranking embodiment are illustrated in detail below in FIGS. 4-10

FIG. 4 is a high level overview functional block diagram illustrating the output operations 400 of the Fairly Calibrated Distribution Matrix Modeling module 202, according to the exemplary employee ranking example embodiment. In operation 310, the user 132 selects a desired distribution output representation. For the 24 box grid of the employee ranking embodiment, a user may select a two dimensional performance and potential view in operation 320, a performance only view in operation 330, or a potential only view in operation 340.

Upon user selection of a performance and potential view 320 in the exemplary employee ranking embodiment, a search filter is applied to the box grid data 322.

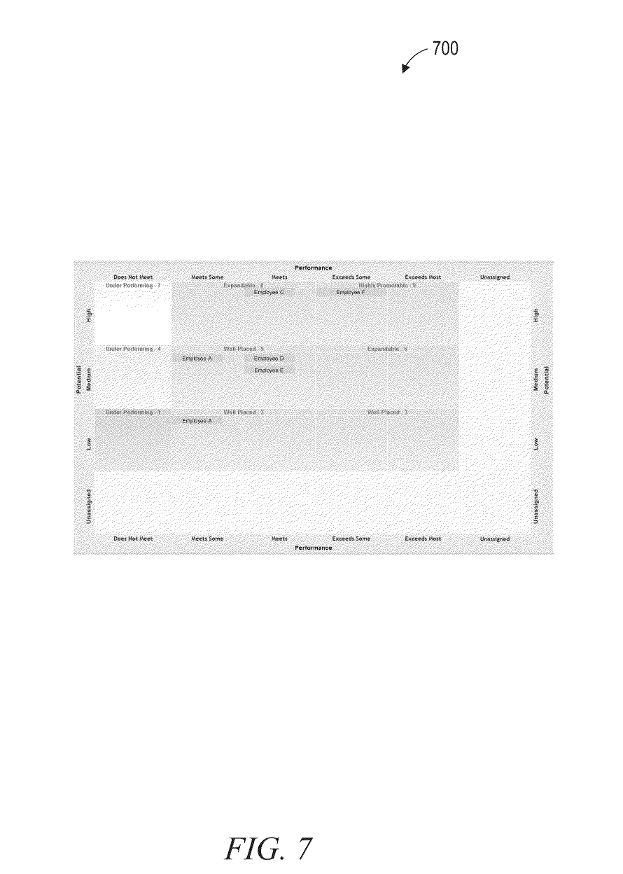

The search filter 322 accesses a data base 402 to retrieve employee detail data 404, current employee rating and potential data 406, adjusted rating and potential data 408, access override data 410 and organizational goals and guidelines data 412 as saved by the user 132. A fairly calibrated bell curve distribution is calculated 324 in accordance with operation 324 and a box grid view output is generated 326. Performance and potential views are further detailed below in FIG. 7.

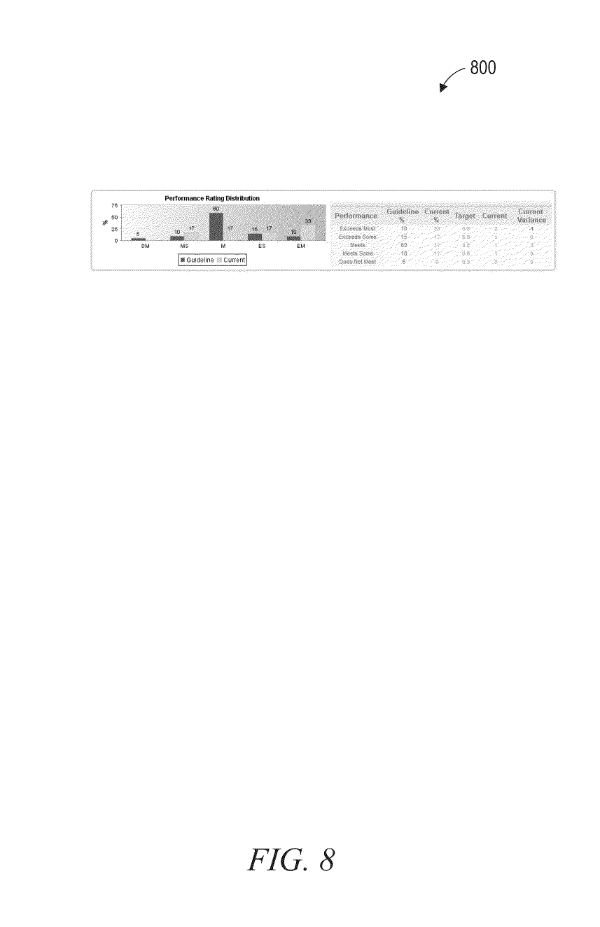

Upon user selection of a performance view 330 in the exemplary employee ranking embodiment, a search filter is applied to the grid data 332. The search filter 332 accesses a data base 402 to retrieve employee detail data 404, current employee rating and potential data 406, adjusted rating and potential data 408, access override data 410 and organizational goals and guidelines data 412 as saved by the user 132. A fairly calibrated bell curve distribution is calculated in accordance with operation 334. A pictorial chart view and its associated table data output is generated 336. Performance views are further detailed below in FIG. 8.

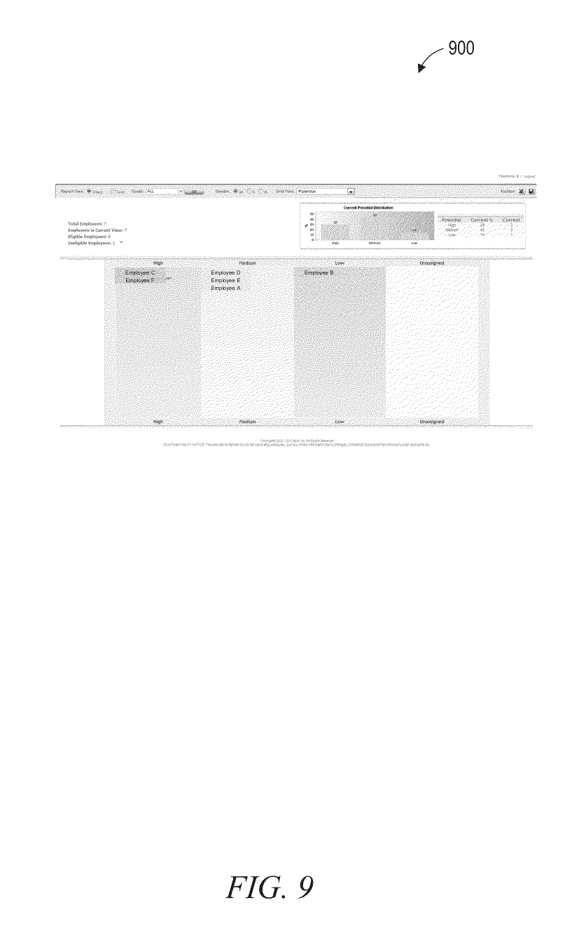

Upon user selection of a potential view 340 in the exemplary employee ranking embodiment, a search filter is applied to the grid data 342. The search filter 342 accesses a data base 402 to retrieve employee detail data 404, current employee rating and potential data 406, adjusted rating and potential data 408, access override data 410 and organizational goals and guidelines data 412 as saved by the user 132. A fairly calibrated bell curve distribution is calculated in accordance with operation 344. A potential chart view and its associated table data output is generated 346. Potential views are further detailed below in FIG. 9.

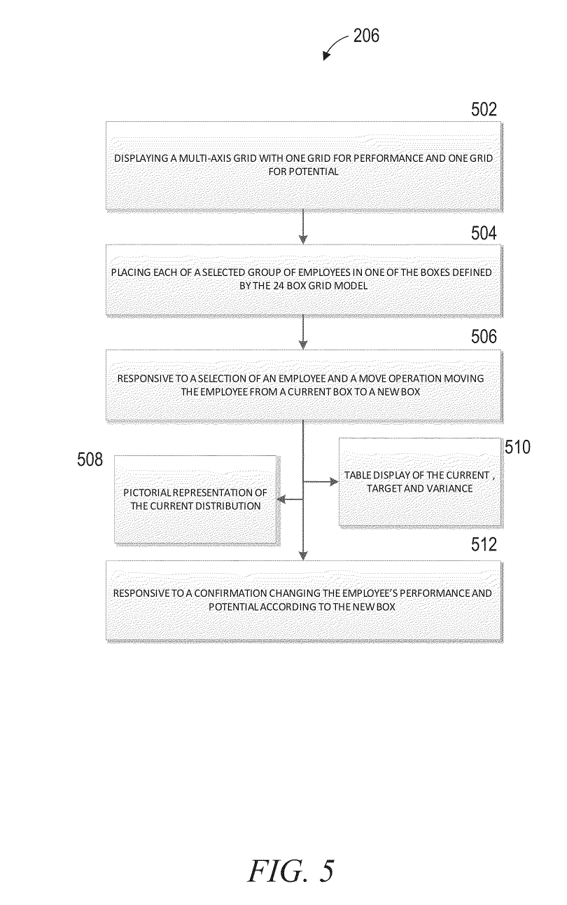

FIG. 5 shows a high level functional block diagram of an automated bell curve distribution simulation module for Fairly Calibrated Distribution Matrix Modeling 500, according to the exemplary employee ranking performance and potential view example embodiment. Functional block 502 displays a multi-axis grid having an X-axis grid for performance and a Y-axis grid for potential associated with a 24 box grid system. In functional block 504, the system places each employee in one of the boxes defined by the 24 box grid model based on the manager rating. The 24 box grid structure is detailed below in FIG. 7.

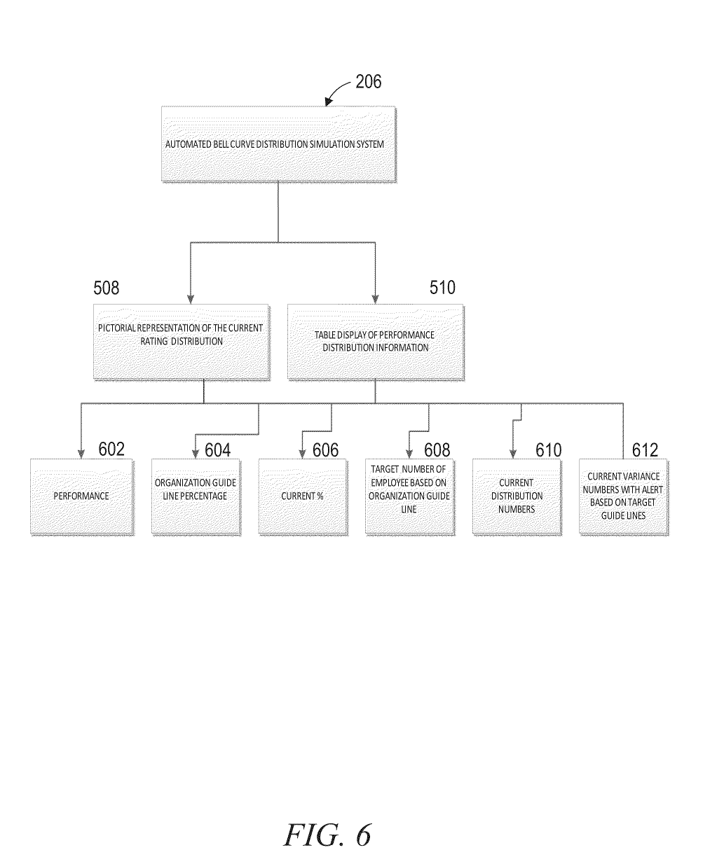

The user may change, or move, the employee from its current box to a new box within the grid causing the automated bell curve distribution simulation system to provide an updated bell curve based on the employee's new position as shown by functional block 506. Pictorial representations of the current distribution alongside table displays of the current organizational goal and guideline targets and acceptable variances are displayed as shown by functional blocks 508 and 510 respectively. Functional blocks 508 and 510 are further detailed in FIGS. 6-10. Functional block 512 then shows automated bell curve distribution simulation system module responsive to a confirmed, or saved, new grid position of one or more employees.

FIG. 6 shows a detailed functional block diagram of automated bell curve distribution simulation module 206 output for Fairly Calibrated Distribution Matrix Modeling, according to the exemplary employee ranking performance and potential view example embodiment. The automated bell curve distribution simulation module 206 comprises main components for pictorial representations 508 and table displays 510 of the current distributions. The components 508 and 510 calculate and generate displays for the current performance distributions 602, organization guideline percentages met by the current grid allocation 604, current distributions by percentage of 606, target number of employees 608, current distributions 610 and variances based on guidelines 612. As the user 132 changes, or moves, the employee from one grid box position to another box location within the grid, the automated bell curve distribution simulation system module 206 provides updated bell curve pictorial/graphical and table representations based on the new box grid position(s).

The user 132 may identify the performance rating distribution for each category in pictorial notation and also the table representations with current, target, variance and guidelines percentages. This module 206 allows the manager (user) 132 to ensure that the employees' performances are in-line with operational and strategic goals of the organization by providing the table data with alerts. The current alert indicator will be displayed when the employee performance data does not comport with organizational goals and guidelines. The manager (user) 132 may normalize the distributions by means of a drag and drop feature to modify the 24 box grid employee positions. New pictorial and table representations 602-612 are calculated and displayed for changed grid box positions until the manager (user) 132 is satisfied with the current results.

FIGS. 7-10 illustrate user interfaces generated by the pictorial representation 508 and table display 510 components of the automated bell curve distribution simulation system module 206, according to the exemplary employee ranking embodiment.

FIG. 7 illustrates an example user interface showing a two dimensional performance versus potential output page, consistent with some embodiments of the invention. In the example of FIG. 7, page 700 describes an X-axis grid for performance and a Y-axis grid for potential associated with placement of six employees in a 24 box grid system. The description may include performance metrics comprising Does Not Meet, Meets Some, Meets, Exceeds Some, Exceeds Most and Unassigned. The description may include Potential metrics comprising Low, Medium, High and Unassigned. Also depicted on this page are manager (user) 132 placements of the employees within the grid box system reflecting the metrics assigned to each employee.

FIG. 8 illustrates an example user interface showing a performance rating distribution output page, consistent with some embodiments of the invention. In the example of FIG. 8, page 800 describes a pictorial performance chart view and its associated table data display. The description may include the percentage of employees having performance metric values of Does Not Meet, Meets Some, Meets, Exceeds Some, Exceeds Most and Unassigned. The description may include a table data display reflective of the performance distributions by percentages.

FIG. 9 illustrates an example user interface showing a potential rating distribution output page, consistent with some embodiments of the invention. In the example of FIG. 9, page 900 describes a pictorial potential chart view and its associated table data display. The description may include the percentage of employees having potential metric values of High, Medium, Low, and Unassigned. The description may include a table data display reflective of the potential distributions by percentages. Exemplary user 132 output selection control options may be illustrated as radio button inputs.

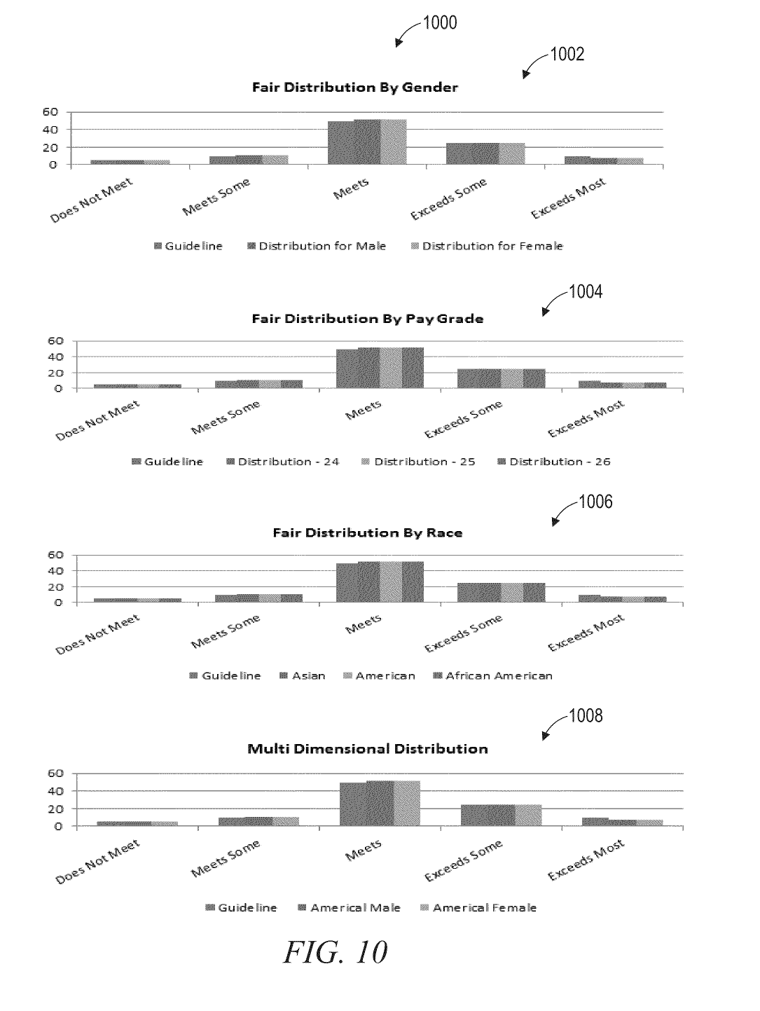

FIG. 10 illustrates an example user interface showing a distribution by demographic criteria output page, consistent with some embodiments of the invention. In the example of FIG. 10, page 1000 describes pictorial chart views of distributions by demographic factors. In the employee ranking embodiment for example, pictorial charts may be generated and output for distributions by gender 1002, pay level or grade 1004, and race 1006. A holistic distribution 1008 may additionally be shown for purposes of comparison to the demographic groups.

The manager (user) 132 may identify the performance rating distribution for each demographic category in pictorial notation as well as a table representation with current, target, variance and guidelines percentages. Thus, the manager may ensure that individual employee's, demographic groups of employees, and the employee group as a whole, exhibit performance in line with operational and strategic goals of an organization by providing the table data set with warning alert. The current invention allows the user to measure the employee's performance against various exemplary data sets such as Fair distribution by Gender, Fair distribution by Pay Grade, or Fair distribution by Race. If any of the current distribution are not in line with organization goals, the user will be able to normalize the distribution data set using the 24 box grid model with the drag and drop feature, providing the managers with a mechanism to ensure the distributions are fair at the sub levels by extending for any multi-level drill down or criteria combinations.

FIG. 11 is a block diagram illustrating components of a machine 1100, according to some example embodiments, able to read instructions 1124 from a machine-readable medium 1122 (e.g., a machine-readable storage medium, a computer-readable storage medium, or any suitable combination thereof) and perform any one or more of the methodologies discussed herein, in whole or in part. Specifically, FIG. 11 shows the machine 1100 in the example form of computer system within which the instructions 1124 (e.g., software, a program, an application, an applet, an app, or other executable code) for causing the machine 1100 to perform any one or more of the methodologies discussed herein may be executed, in whole or in part. In alternative embodiments, the machine 1100 operates as a standalone device or may be connected (e.g., networked) to other machines. In a networked deployment, the machine 1100 may operate in the capacity of a server machine or a client machine in a server-client network environment, or as a peer machine in a distributed (e.g., peer-to-peer) network environment. The machine 1100 may be a server computer, a client computer, a personal computer (PC), a tablet computer, a laptop computer, a netbook, a cellular telephone, a smartphone, a STB, a personal digital assistant (PDA), a web appliance, a network router, a network switch, a network bridge, or any machine capable of executing the instructions 1124, sequentially or otherwise, that specify actions to be taken by that machine. Further, while only a single machine is illustrated, the term “machine” shall also be taken to include any collection of machines that individually or jointly execute the instructions 1124 to perform all or part of any one or more of the methodologies discussed herein.

The machine 1100 includes a processor 1102 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 1104, and a static memory 1106, which are configured to communicate with each other via a bus 1108. The processor 1102 may contain microcircuits that are configurable, temporarily or permanently, by some or all of the instructions 1124 such that the processor 1102 is configurable to perform any one or more of the methodologies described herein, in whole or in part. For example, a set of one or more microcircuits of the processor 1102 may be configurable to execute one or more modules (e.g., software modules) described herein.

The machine 1100 may further include a graphics, or video, display 1110 (e.g., a plasma display panel (PDP), a light emitting diode (LED) display, a liquid crystal display (LCD), a projector, a cathode ray tube (CRT), or any other display capable of displaying graphics or video). The machine 1100 may also include an alphanumeric input device 1112 (e.g., a keyboard or keypad), a cursor control device 1114 (e.g., a mouse, a touchpad, a trackball, a joystick, a motion sensor, an eye tracking device, or other pointing instrument), a storage, or drive, unit 1116, an audio signal generation device 1118 (e.g., a sound card, an amplifier, a speaker, a headphone jack, or any suitable combination thereof), and a network interface device 1120.

The storage unit 1116 includes the machine-readable medium 1122 (e.g., a tangible and non-transitory machine-readable storage medium) on which are stored the instructions 1124 embodying any one or more of the methodologies or functions described herein. The instructions 1124 may also reside, completely or at least partially, within the main memory 1104, within the processor 1102 (e.g., within the processor's cache memory), or both, before or during execution thereof by the machine 1100. Accordingly, the main memory 1104 and the processor 1102 may be considered machine-readable media (e.g., tangible and non-transitory machine-readable media). The instructions 1124 may be transmitted or received over the network 1190 via the network interface device 1120. For example, the network interface device 1120 may communicate the instructions 1124 using any one or more transfer protocols (e.g., hypertext transfer protocol (HTTP)).

In some example embodiments, the machine 1100 may be a fixed or portable computing device, such as a desktop computer, laptop computer, smart phone or tablet computer, and have one or more additional input components 1130 (e.g., sensors or gauges). Examples of such input components 1130 include an image input component (e.g., one or more cameras), an audio input component (e.g., a microphone), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of modules described herein.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 1122 is shown in an example embodiment to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing the instructions 1124 for execution by the machine 1100, such that the instructions 1124, when executed by one or more processors of the machine 1100 (e.g., processor 1102), cause the machine 1100 to perform any one or more of the methodologies described herein, in whole or in part. Accordingly, a “machine-readable medium” refers to a single storage apparatus or device, as well as cloud-based storage systems or storage networks that include multiple storage apparatus or devices. The term “machine-readable medium” shall accordingly be taken to include, but not be limited to, one or more tangible data repositories in the form of a solid-state memory, an optical medium, a magnetic medium, or any suitable combination thereof.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

1. A method for calibrating performance data comprising:
evaluating performance of a plurality of individual entities by assigning each entity a performance evaluation metric;
evaluating potential of a plurality of the individual entities by assigning each entity a potential evaluation metric;
placing the individual entities in matrix positions according to the assigned evaluation metrics to produce matrix data;
calibrating the matrix data to produce unbiased and evenly distributed performance rankings of the individual entities; and
creating and displaying performance ranking model output views.

2. The method of claim 1, wherein:
placing the individual entities in matrix positions is repeated until evenly distributed performance rankings comport with organizational guidelines.

3. The method of claim 1, wherein:
placing the individual entities in matrix positions is performed using a drag and drop feature.

4. The method of claim 1, wherein:
creating and displaying performance ranking model output views comprises creating and displaying a multi-dimensional view.

5. The method of claim 1, wherein:
creating and displaying performance ranking model output views comprises the creating and displaying of performance rankings based one or more individual demographic criteria.

6. The method of claim 1, wherein:
calibrating the matrix data comprises alerting a user when the calibrated data does not comport with organizational guidelines.

7. The method of claim 1, wherein:
creating and displaying performance ranking model output views comprises creating one of a performance view, a potential view, a holistic view, a multi-dimensional potential and performance view, a demographic view or a combination of demographics view.

8. The method of claim 1, wherein:
each unique combination of performance evaluation and potential evaluation metrics corresponds to well-defined placement levels to which employees would be tagged.

9. The method of claim 1, wherein:
a user assigns a potential evaluation metric of Low, Medium, High or Unassigned to an individual entity.

10. The method of claim 1 wherein:
a user assigns a performance evaluation metric of Does Not Meet, Meets Some, Meets, Exceeds Some, Exceeds Most or Unassigned to an individual entity.

11. A non-transitory machine-readable storage medium comprising instructions that, when executed by one or more processors of a machine, cause the machine to perform operations comprising:
evaluating performance of a plurality of individual entities by assigning each entity a performance evaluation metric;
evaluating potential of a plurality of the individual entities by assigning each entity a potential evaluation metric;
placing the individual entities in matrix positions according to the assigned evaluation metrics to produce matrix data;
calibrating the matrix data to produce unbiased and evenly distributed performance rankings of the individual entities; and
creating and displaying performance ranking model output views.

12. The non-transitory machine-readable storage medium of claim 11, wherein:
placing the individual entities in matrix positions is repeated until evenly distributed performance rankings comport with organizational guidelines.

13. The non-transitory machine-readable storage medium of claim 11, wherein:
creating and displaying performance ranking model output views comprises creating and displaying a multi-dimensional view.

14. The non-transitory machine-readable storage medium of claim 11, wherein:
creating and displaying performance ranking model output views comprises the creating and displaying of performance rankings based one or more individual demographic criteria.

15. A portable or fixed device comprising:
a fairly calibrated distribution matrix modeling module configured to evaluate performance of a plurality of individual entities by assigning each entity a performance evaluation metric and evaluate potential of a plurality of the individual entities by assigning each entity a potential evaluation metric,
a box grid system module configured to place the individual entities in matrix positions according to the assigned evaluation metrics to produce matrix data; and
an automated bell curve distribution system module configured to calibrate the matrix data to produce unbiased and evenly distributed performance rankings of the individual entities and to create and display performance ranking model output views comprises creating and displaying a multi-dimensional view.

16. The portable or fixed device of claim 15, wherein:
the fairly calibrated distribution matrix modeling module is further configured to place the individual entities in matrix positions is repeated until evenly distributed performance rankings comport with organizational guidelines.

17. The portable or fixed device of claim 15, wherein:
the automated bell curve distribution system module is further configured to create and display a multi-dimensional view.

18. A system comprising:
a processor configured to execute instructions to
evaluate performance of a plurality of individual entities by assigning each entity a performance evaluation metric;
evaluate potential of a plurality of the individual entities by assigning each entity a potential evaluation metric;
place the individual entities in matrix positions according to the assigned evaluation metrics to produce matrix data;
calibrate the matrix data to produce unbiased and evenly distributed performance rankings of the individual entities; and
a video graphics display for creating and displaying performance ranking model output views.

19. The system of claim 18, wherein:
the fairly calibrated distribution matrix modeling module is further configured to place the individual entities in matrix positions is repeated until evenly distributed performance rankings comport with organizational guidelines.

20. The system of claim 18, wherein:
the automated bell curve distribution system module is further configured to create and display a multi-dimensional view.
